(19) United States
(12) Patent Application Publication
(10) Pub. No.: US 2010/0303277 A1
(43) Pub. Date: Dec. 2, 2010

(54) CORDLESS POWERLINE AUDIO SPEAKERS

(75) Inventors: Jeff W. King, San Diego, CA (US); William A. McCarty, San Diego, CA (US)

Correspondence Address: KNOBBE MARTENS OLSON & BEAR LLP, 2040 MAIN STREET, FOURTEENTH FLOOR, IRVINE, CA, 92614, US

(73) Assignee: KSC Industries Incorporated, Chula Vista, CA (US)

(21) Appl. No.: 12/475,339

(22) Filed: May 29, 2009

(51) Int. Cl. H04R 1/02

(52) U.S. Cl. 381/394

(57) ABSTRACT

A speaker includes an audio transducer and a coupling that provides both an electrical connection and a mechanical support function. In some embodiments, the coupling is a light bulb screw base. In other embodiments, standard parallel power input blades can be utilized. With this design, an audio distribution system requiring no specialized audio signal cabling may be constructed.

### BACKGROUND OF THE INVENTION

Home theaters, stereos, and other home entertainment systems typically require a large number of wired connections between receivers, DVD or CD players, amplifiers, and speakers, as well as wired power connections to AC power outlets. These can be unsightly and difficult to route along walls, under carpets, or through other out of the way areas of a room or household.

To help alleviate these issues, commercial products have been introduced that distribute the audio signal wirelessly through RF communication methods. Audio distribution has also been performed over household AC power wiring. Furthermore, new home construction often includes a variety of pre-installed cabling runs for audio signal distribution.

Each of these solutions has drawbacks, however. Radio-frequency wireless communication can require expensive circuitry, and signal strength throughout the house can vary widely. Pre-installed cable requires additional expense during home construction, not only for the materials, but also because different vendors are often required for installing different cable types.

Accordingly, new techniques and apparatus for easily and conveniently distributing audio throughout homes and other structures is needed.

### SUMMARY OF THE INVENTION

In one embodiment, the invention is a speaker comprising an audio transducer and a coupling configured to receive both power and signal inputs from household electrical power wiring and also configured to mechanically support the audio transducer and rigidly affix the audio transducer to a household electrical power outlet.

The speaker may additionally comprise an audio amplifier. In another embodiment, the speaker may also comprise a powerline signal receiver configured to receive audio information from the coupling and route at least a portion of the information to the amplifier for amplification.

In some embodiments, the coupling comprises a light bulb base coupling such as, for example, an Edison screw.

In another embodiment, a speaker for an audio distribution system comprises an audio transducer, a light bulb base coupling, and an amplifier coupled to receive power from the light bulb screw base and couple to output audio signals to the audio transducer. In some embodiments, the audio signal can be received wirelessly. In others, the signal can be received via powerline signal communication methods.

### BRIEF DESCRIPTION OF THE DRAWINGS

FIG. 1 is a block diagram of a speaker in accordance with one embodiment of the invention.

FIG. 2 is a perspective view of a speaker in accordance with a one embodiment of the invention.

FIG. 3 is a block diagram of an embodiment illustrating other components of some speaker embodiments.

FIG. 4 is a block diagram of another embodiment of the invention.

### DETAILED DESCRIPTION OF THE PREFERRED EMBODIMENT

The inventions will now be described in conjunction with the Figures, wherein like numerals designate like components.

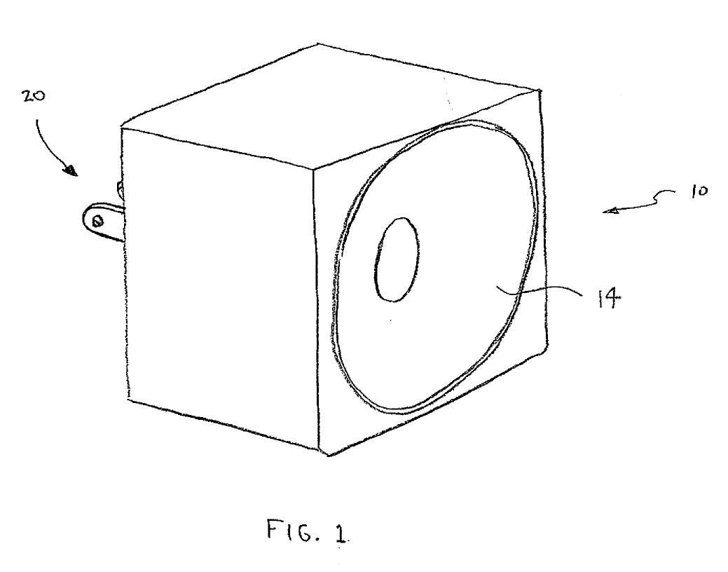

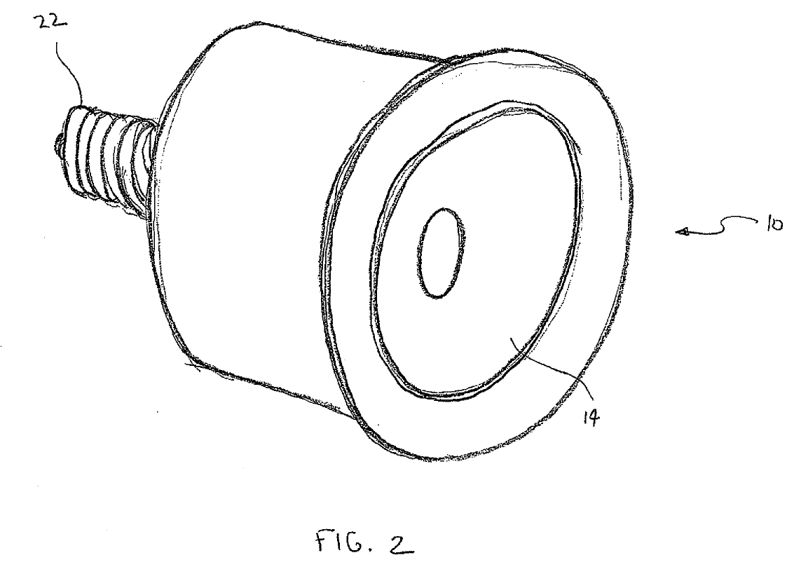

FIGS. 1 and 2 are overall perspective views of two different embodiments of speakers 10 that include a fixture coupling that can provide both a mechanical and electrical attachment for a speaker to standard electrical connection formats commonly found in residential structures. In the embodiment of FIG. 1, the coupling 20 is a standard power plug format comprising a pair of parallel power input blades. In this embodiment, the power input plug format would be configured to mate with a standard household appliance electrical outlet receptacle. Many different standard outlet receptacle configurations are possible that the speaker coupling could be configured to mate with, including those currently defined in well known and published ANSI/NEMA standards. Some possible examples include NEMA 1-15R, which is a two prong parallel blade 120 V configuration, and the NEMA 5-15R configuration which is a grounded parallel blade 120 V configuration. In some embodiments, the coupling could include two sets of blades to plug into a standard duplex receptacle. To improve mechanical stability, the plug/receptacle combination might be a locking type. Locking receptacles include the NEMA L1-15R and L5-15R. The speaker cone 14 which forms the audio transducer may be mounted on the opposite side of the speaker housing as the coupling or it may be mounted on another housing surface.

In the embodiment of FIG. 2, the speaker includes a light bulb base coupling 22 instead of a parallel blade coupling configuration. Advantageously, the light bulb base coupling is configured to fit standard light bulb receptacles. Typically, household bulbs have a medium screw base, which is also referred to as an Edison screw. This configuration is 1 1/16 inches in diameter with 7 threads per inch. Some bulbs that are designed to discourage bulb theft in public places have a base that looks like a medium base but isn't. Some have a left-hand thread; others are called “admedium,” and are slightly larger (1 5/32 inches) so they can't be used in a standard household socket. Other common screw bases include mogul, which is 1 19/32 inch in diameter, some high-wattage bulbs, and outdoor security lights. Screw-in adapters that convert mogul sockets to medium screw are commercially available. Some other standard socket styles include a ⅝ inch in diameter which are often the bulbs in refrigerators and some other appliances, a ½ inch in diameter used for outdoor Christmas tree lights, a 7/16 in. diameter, and a ⅜ in. diameter. Any of these or any other standard style could be used in conjunction with the invention.

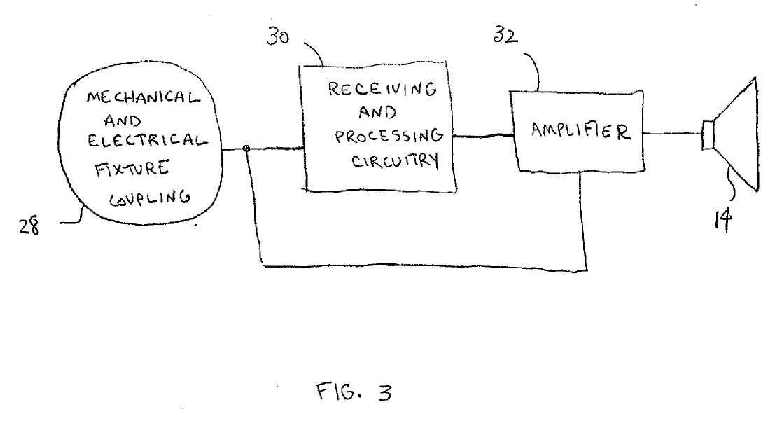

FIG. 3 shows a block diagram of one invention embodiment illustrating other components of some speaker embodiments. The speaker includes an electrical and mechanical fixture coupling 28, which as described above, is preferably an industry standard style such as a parallel blade outlet plug, light bulb base, or other such configuration. In some advantageous embodiments, the coupling fully supports the speaker off the floor so no floor space is needed.

The speaker also included receiving and processing circuitry 30 and an amplifier 32. The receiving and processing circuitry 30 may receive both power and an audio signal from the fixture coupling 28. In some embodiments, the audio signal may be received wirelessly by RF or IR transmission techniques which are also known in the art. The receiving and processing circuitry includes the isolation, detection, and processing of an analog or digital audio signal according to well known techniques. Some of these are described in more detail in co-pending U.S. Patent Application Publication Nos. 2003-0210796-A1 and 2004-0234088-A1 and U.S. Pat. No. 7,346,332, which are hereby incorporated by reference in their entirety.

The amplifier 32, which may be any known type of analog or digital amplifier, receives a processed signal from the receiving and processing circuitry 30, and also receives power from the fixture coupling 28. The amplifier outputs the amplified audio signal to the audio transducer 14.

With this design, the speaker needs no additional mechanical coupling to the structure or electrical coupling to the audio system other than that provided by the coupling 28.

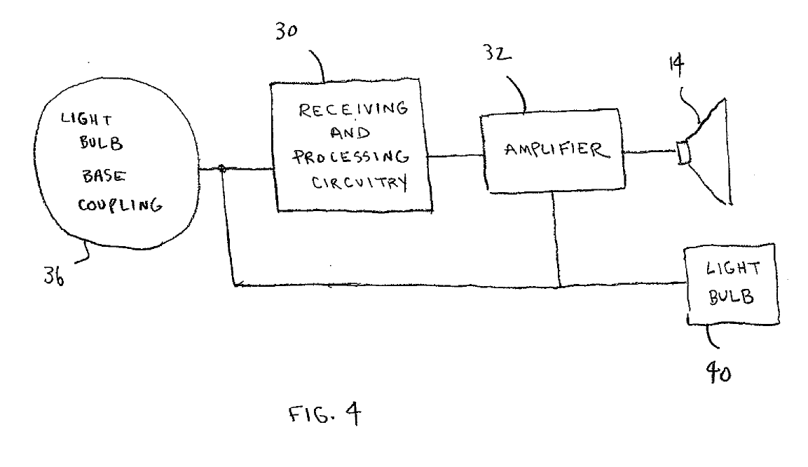

FIG. 4 illustrates a block diagram of another embodiment of the invention. In this embodiment, the coupling comprises a light bulb base coupling 36, which may be configured in accordance with the description of FIG. 2.

The embodiment of FIG. 4 also includes a light bulb 40, which also receives power from the light bulb base coupling. In this embodiment, a single device can function as both a light and a speaker and be plugged into a standard light bulb socket.

In other embodiments, electrical outlets could be designed specifically for speakers. These could have the mechanical and electrical properties especially suitable for supporting speakers and their audio communication and power requirements. The mechanical and electrical fixture coupling described above would then be configured to mate with such a “speaker receptacle” rather than the appliance outlet or light bulb socket embodiments described above. Residential or other structures could then be wired by a single electrician to have power outlets, light fixtures, and speaker fixtures all tied to the 120 V power cabling running throughout the structure.

It will be appreciated that the inventions described above can be implemented in a wide variety of ways, and is defined not by any specific embodiments described above, but by the claims presented below.

What is claimed is:

1. A speaker comprising:
an audio transducer; and
a coupling configured to receive both power and signal inputs from household electrical power wiring and also configured to mechanically support said audio transducer and rigidly affix said audio transducer to a household electrical power outlet.

2. The speaker of claim 1, additionally comprising an audio amplifier.

3. The speaker of claim 2, additionally comprising a powerline signal receiver configured to receive audio information from said coupling and route at least a portion of said information to said amplifier for amplification.

4. The speaker of claim 1, wherein said coupling comprises a light bulb base coupling.

5. The speaker of claim 4, wherein said coupling comprises an Edison screw.

6. The speaker of claim 4, additionally comprising a light bulb coupled to receive input power from said light bulb base coupling.

7. The speaker of claim 5, additionally comprising a light bulb coupled to receive input power from said Edison screw.

8. The speaker of claim 1, wherein said coupling comprises a pair of parallel power input blades.

9. The speaker of claim 8, wherein said coupling is configured to mate with either a NEMA 1-15R or NEMA 5-15R receptacle.

10. The speaker of claim 8, wherein said coupling comprises four parallel power input blades.

11. A speaker for an audio distribution system comprising:
an audio transducer;
a light bulb base coupling; and
an amplifier coupled to receive power from said light bulb screw base and couple to output audio signals to said audio transducer.

12. The speaker of claim 11, additionally comprising processing circuitry for processing a received signal including audio information.

13. The speaker of claim 11, additionally comprising a wireless signal receiver configured to wirelessly receive audio information and route at least a portion of said information to said amplifier for amplification.

14. The speaker of claim 11, additionally comprising a powerline signal receiver configured to receive audio information from said light bulb base coupling and route at least a portion of said information to said amplifier for amplification.
